(19) United States
(12) Patent Application Publication
(10) Pub. No.: US 2024/0031607 A1
(43) Pub. Date: Jan. 25, 2024

(54) SCALING LIST CONTROL IN VIDEO CODING

(71) Applicant: InterDigital CE Patent Holdings, SAS, Paris (FR)

(72) Inventors: Karam Naser, Mouazé (FR); Philippe De Lagrange, Betton (FR); Fabrice LeLeannec, Betton (FR); Philippe Bordes, Laille (FR)

(21) Appl. No.: 17/916,911

(22) PCT Filed: Apr. 9, 2021
(86) PCT No.: PCT/EP2021/059275

§ 371 Date: Oct. 4, 2022

(30) Foreign Application Priority Data
Apr. 14, 2020 (EP) 20315158.4

(51) Int. Cl. H04N 19/70; H04N 19/176; H04N 19/126; H04N 19/60; H04N 19/186

(52) U.S. Cl. CPC H04N 19/70; H04N 19/176; H04N 19/126; H04N 19/60; H04N 19/186

(57) ABSTRACT

An encoder, such as a Versatile Video Coding encoder, can disable scaling matrices for coding units employing Adaptive Color Transforms (ACT) or joint chroma coding (JCBCR) by using the existing Adaptation Parameter Set (APS) flag for Low Frequency Non-Separable Transform (LFNST). In one embodiment a process or device to encode or decode video data uses syntax that uses the same flag to control scaling matrices when Low Frequency Non-Separable Transform is used to control the scaling matrices for ACT and JCBCR. In a second embodiment, a process or device to encode or decode video data uses syntax that controls the scaling matrices for ACT only. In another embodiment, a. process or device to encode or decode video data uses syntax that controls the scaling matrices for JCBCR only. In another embodiment, a process or device to encode or decode video data uses syntax that controls the scaling matrices at a Sequence Parameter Set level.

### TECHNICAL FIELD

At least one of the present embodiments generally relates to a method or an apparatus for video encoding or decoding.

### BACKGROUND

To achieve high compression efficiency, image and video coding schemes usually employ prediction, including spatial and/or motion vector prediction, and transforms to leverage spatial and temporal redundancy in the video content.

Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction. A number of coding tools can be used in the process of coding and decoding, including transforms and inverse transforms.

### SUMMARY

Drawbacks and disadvantages of the prior art may be addressed by the general aspects described herein, which are directed to allowing an encoder to disable scaling matrices for adaptive color transform tool or joint chroma coding.

These and other aspects, features and advantages of the general aspects will become apparent from the following detailed description of exemplary embodiments, which is to be read in connection with the accompanying drawings.

### BRIEF DESCRIPTION OF THE DRAWINGS

FIG. 1 shows a standard, generic video compression scheme

FIG. 2 shows a standard, generic, video compression scheme.

FIG. 3 shows a typical processor arrangement in which the described embodiments may be implemented.

### DETAILED DESCRIPTION

To achieve high compression efficiency, image and video coding schemes usually employ prediction, including motion vector prediction, and transformations to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

The following general aspects are in the field of video compression, more specifically the high-level syntax for allowing an encoder to disable scaling matrices for adaptive color transform tool or joint chroma coding.

The general aspects described are related to a video encoding and decoding standard, such as the Versatile Video Coding (VVC) standard. The embodiments deal with high level syntax related to video coding tools.

The invention is in the field of video compression. More specifically, it proposes to allow a video encoder to disable the scaling matrices for adaptive color transform tool or joint chroma coding.

Scaling matrices are allowed in VVC for visual optimization of quantization where certain frequency coefficients can be upscaled/downscaled according to their visual importance. The scaling matrices are signaled in the adaptation parameters set (APS) for all transform unit sizes, both for luma and chroma. It is noted that the scaling list can be optionally deactivated for the secondary transform, low frequency non-separable transform (LFNST), as the transform coefficients generated from LFNST do not have a simple frequency mapping. Compared to regular “primary” transforms allowed in VVC (DCT2, DCT8, DST7), the notion of frequency is clear where the basis functions correspond to the frequency of zero passing. That is, the lowest frequency basis function has zero-frequency and the nth basis function has n zero passing. Therefore, the visual significance of these basis is clearer than LFNST and the scaling matrices can be designed accordingly. Therefore, deactivating scaling matrices for LFNST is an important option for an encoder.

Similar to LFNST, VVC is equipped with the adaptive color transform (ACT), where the RGB input is mapped to a different color space that has less correlation and therefore better compressed. It is noted that after ACT, the frequency components are not the same as a regular transform. If the encoder opts to use the scaling matrices, it is obliged to use them for ACT as well. Therefore, a similar flag to LFNST is needed to disallow scaling matrices for coding units (CU's) that employ ACT.

There is a recent contribution in JVET-R0380. It proposes to add an APS flag to disable ACT scaling matrices. However, adding another flag to APS causes signaling overhead that is generally to be avoided. It is preferred to re-use the existing flags to solve the problem, or to introduce the flag at higher level (such as in a Sequence Parameter Set, SPS).

This invention proposes allowing an encoder, such as a VVC encoder, to disable the scaling matrices for CU's employing ACT or joint chroma coding (joint cb-cr or JCBCR) by using the existing APS flag for LFNST.

In the aps syntax, there exists a flag to disable scaling matrices for LFNST (scaling_matrix_for_lfnst_disabled_flag). Specifically, it is coded as follows:

| | Descriptor |
|---|---|
| scaling_list_data( ) { | |
| scaling_matrix_for_lfnst_disabled_flag | u(1) |
| scaling_list_chroma_present_flag | u(1) |
| ... | |

Its semantic is as follows:

scaling_matrix_for_lfnst_disabled_flag equal to 1 specifies that scaling
matrices are not applied to blocks coded with LFNST. scaling_matrix_
for_lfnst_disabled_flag equal to 0 specifies that the scaling matrices
may apply to the blocks coded with LFNST.

In the decoding process, its value is used here:

```
- The intermediate scaling factor m[ x ][ y ] is derived as follows:
  - If one or more of the following conditions are true, m[ x ][ y ] is set equal to 16:
    - slice_explicit_scaling_list_used_flag is equal to 0.
    - transform_skip_flag[ xTbY ][ yTbY ][ cIdx ] is equal to 1.
    - scaling_matrix_for_lfnst_disabled_flag is equal to 1 and ApplyLfnstFlag is equal to 1.
```

That is, the scaling factor (m[x][y]) is set to 16, which is the default value of no scaling matrices, when scaling_matrix_for_lfnst_disabled_flag is 1 and LFSNT is applied for the current CU. In the following embodiment, the same is done for ACT and JCBCR.

### Embodiment 1: APS Control

### Embodiment 1-a: ACT and JCBCR

Here, it is proposed to use the same flag “scaling_matrix_for_lfnst_disabled_flag” to control the scaling matrices for ACT and JCBCR. That is, change the name to scaling_matrix_for_lfnst_act_jcbcr_disabled_flag and when it is set to 1, disable scaling list for CU's where LFNST, ACT or JCBCR is enabled. The corresponding changes are (added part shaded):

| | Descriptor |
|---|---|
| scaling_list_data( ) { | |
| scaling_matrix_for_lfnst_act_jcbcr_disabled_flag | u(1) |
| scaling_list_chroma_present_flag | u(1) |
| ... | |

Similarly, the semantics are modified:

scaling_matrix_for_lfnst_act_jcbcr_disabled_flag equal to 1 specifies
that scaling matrices are not applied to blocks coded with LFNST,
ACT or JCBCR. scaling_matrix_for_lfnst_disabled_flag equal to
0 specifies that the scaling matrices may apply to the blocks coded
with LFNST, ACT or JCBCR.

The decoding process is modified as follows:

```
- The intermediate scaling factor m[ x ][ y ] is derived as follows:
  - If one or more of the following conditions are true, m[ x ][ y ] is set equal to 16:
    - slice_explicit_scaling_list_used_flag is equal to 0.
    - transform_skip_flag[ xTbY ][ yTbY ][ cIdx ] is equal to 1.
    - scaling_matrix_for_lfnst_act_jcbcr_disabled_flag is equal to 1 and ApplyLfnstFlag is equal to 1.
    - scaling_matrix_for_lfnst_act_jcbcr_disabled_flag is equal to 1 and
      cu_act_enabled_flag[ xTbY ][ yTbY ] is equal to 1.
    - scaling_matrix_for_lfnst_act_jcbcr_disabled_flag is equal to 1 and
      tu_joint_cbcr_residual_flag[ xTbY ][ yTbY ] is equal to 1
```

### Embodiment 1-b: ACT Only

If ACT only solution is considered, that is, JCBCR scaling list disabling is not taken into consideration, the following changes are made:

| | Descriptor |
|---|---|
| scaling_list_data( ) { | |
| scaling_matrix_for_lfnst_act_disabled_flag | u(1) |
| scaling_list_chroma_present_flag | u(1) |
| ... | |

Similarly, the semantics are modified:

scaling_matrix_for_lfnst_act_disabled_flag equal to 1 specifies that scaling
matrices are not applied to blocks coded with LFNST or ACT. scaling_
matrix_for_lfnst_disabled_flag equal to 0 specifies that the scaling
matrices may apply to the blocks coded with LFNST or ACT.

The decoding process is modified as follows:

```
- The intermediate scaling factor m[ x ][ y ] is derived as follows:
  - If one or more of the following conditions are true, m[ x ][ y ] is set equal to 16:
    - slice_explicit_scaling_list_used_flag is equal to 0.
    - transform_skip_flag[ xTbY ][ yTbY ][ cIdx ] is equal to 1.
    - scaling_matrix_for_lfnst_act_disabled_flag is equal to 1 and ApplyLfnstFlag is equal to 1.
    - scaling_matrix_for_lfnst_act_jcbcr_disabled_flag is equal to 1 and
      cu_act_enabled_flag[ xTbY ][ yTbY ] is equal to 1.
```

### Embodiment 1-c: JCBCR Only

If JCBCR is consider only, the following modifications are made:

| | Descriptor |
|---|---|
| scaling_list_data( ) { | |
| scaling_matrix_for_lfnst_jcbcr_disabled_flag | u(1) |
| scaling_list_chroma_present_flag | u(1) |
| ... | |

Similarly, the semantics are modified:

scaling_matrix_for_lfnst_jcbcr_disabled_flag equal to 1 specifies that
scaling matrices are not applied to blocks coded with LFNST or JCBCR.
scaling_matrix_for_lfnst_disabled_flag equal to 0 specifies that the
scaling matrices may apply to the blocks coded with LFNST or JCBCR.

The decoding process is modified as follows:

```
- The intermediate scaling factor m[ x ][ y ] is derived as follows:
  - If one or more of the following conditions are true, m[ x ][ y ] is set equal to 16:
    - slice_explicit_scaling_list_used_flag is equal to 0.
    - transform_skip_flag[ xTbY ][ yTbY ][ cIdx ] is equal to 1.
    - scaling_matrix_for_lfnst jcbcr_disabled_flag is equal to 1 and ApplyLfnstFlag is equal to 1.
    - scaling_matrix_for_lfnst_act_jcbcr_disabled_flag is equal to 1 and
      tu_joint_cbcr_residual_flag[ xTbY ][ yTbY ] is equal to 1
```

### Embodiment 2: SPS Control with Multiple Flags

Instead of controlling scaling matrices at an APS level, it is proposed to control it at an SPS level. This is to reduce the amount of signaling overhead where SPS is less frequently signaled than APS. This can be done, for example, by adding two flags: one for ACT and one for JCBCR to disallow scaling lists for them. These flags are conditionally coded depending on scaling list availability and tool usage. The following changes are proposed:

| | Descriptor |
|---|---|
| seq_parameter_set_rbsp( ) { | |
| ... | |
| sps_joint_cbcr_enabled_flag | u(1) |
| if(sps_joint_cbcr_enabled_flag && sps_explicit_scaling_list_enabled_flag ) | |
| sps_scaling_matrix_for_jcbcr_disabled_flag | u(1) |
| ... | |
| sps_act_enabled_flag | u(1) |
| if(sps_act_enabled_flag && sps_explicit_scaling_list_enabled_flag ) | |
| sps_scaling_matrix_for_act_disabled_flag | u(1) |
| ... | |

The semantics of these flags are:
sps_scaling_matrix_for_jcbcr_disabled_flag equal to 1 specifies that scaling matrices are not applied to blocks coded with JCBCR. sps_scaling_matrix_for_jcbcr_disabled_flag equal to 0 specifies that the scaling matrices may be applied to the blocks coded with JCBCR. When not present, the value of scaling_matrix_for_jcbcr_disabled_flag is inferred to be equal to 1.
sps_scaling_matrix_for_act_disabled_flag equal to 1 specifies that scaling matrices are not applied to blocks coded with ACT. sps_scaling_matrix_for_act_disabled_flag equal to 0 specifies that the scaling matrices may be applied to the blocks coded with ACT. When not present, the value of sps_scaling_matrix_for_act_disabled_flag is inferred to be equal to 1.

The decoding process is changed as follows:

```
- The intermediate scaling factor m[ x ][ y ] is derived as follows:
  - If one or more of the following conditions are true, m[ x ][ y ] is set equal to 16:
    - slice_explicit_scaling_list_used_flag is equal to 0.
    - transform_skip_flag[ xTbY ][ yTbY ][ cIdx ] is equal to 1.
    - scaling_matrix_for_lfnst_disabled_flag is equal to 1 and ApplyLfnstFlag is equal to 1.
    - sps_scaling_matrix_for_act_disabled_flag is equal to 1 and cu_act_enabled_flag[ xTbY ]
      [ yTbY ] is equal to 1.
    - sps_scaling_matrix_for_jcbcr_disabled_flag is equal to 1 and
      tu_joint_cbcr_residual_flag[ xTbY ][ yTbY ] is equal to 1
```

### Embodiment 3: SPS Control with Single Flag

### Embodiment 3-a: ACT and JCBCR

In a prior approach, it is proposed to move the scaling_matrix_for_Ifnst_disabled_flag to the SPS level, as what is proposed in Embodiment 2 for ACT and JCBCR. In this embodiment, it is proposed to have one SPS flag for controlling all the three elements together. It this SPS flag is 1, the scaling list is disabled for LFNST, ACT and JCBCR. The following modifications are proposed:

| | Descriptor |
|---|---|
| seq_parameter_set_rbsp( ) { | |
| ... | |
| sps_lfnst_enabled_flag | u(1) |
| ... | |
| sps_joint_cbcr_enabled_flag | u(1) |
| if ( (sps_lfnst_enabled_flag ∥ sps_joint_cbcr_enabled_flag ∥ | |
| sps_joint_cbcr_enabled_flag) && sps_explicit_scaling_list_enabled_flag ) | |
| sps_scaling_matrix_for_lfnst_act_jcbcr_disabled_flag | u(1) |
| ... | |

The semantics of this flags are:
sps_scaling_matrix_for_lfnst_act_jcbcr_disabled_flag equal to 1 specifies that scaling matrices are not applied to blocks coded with LFNST, ACT or JCBCR. sps_scaling_matrix_for_lfnst_act_jcbcr_disabled_flag equal to 0 specifies that the scaling matrices may be applied to the blocks coded with LFNST, ACT or JCBCR. When not present, the value of scaling_matrix_for_lfnst_act_jcbcr_disabled_flag is inferred to be equal to 1.
   The decoding process is modified as follows:

```
- The intermediate scaling factor m[ x ][ y ] is derived as follows:
  - If one or more of the following conditions are true, m[ x ][ y ] is set equal to 16:
    - slice_explicit_scaling_list_used_flag is equal to 0.
    - transform_skip_flag[ xTbY ][ yTbY ][ cIdx ] is equal to 1.
    - sps_scaling_matrix_for_lfnst_act_jcbcr_disabled_flag is equal to 1 and ApplyLfnstFlag is equal
      to 1.
    - sps_scaling_matrix_for_lfnst_act_jcbcr_disabled_flag is equal to 1 and
      cu_act_enabled_flag[ xTbY ][ yTbY ] is equal to 1.
    - sps_scaling_matrix_for_lfnst_act_jcbcr_disabled_flag is equal to 1 and
      tu_joint_cbcr_residual_flag[ xTbY ][ yTbY ] is equal to 1
```

### Embodiment 3-b: ACT Only

If only ACT is considered, the following modifications are proposed:

| | Descriptor |
|---|---|
| seq_parameter_set_rbsp( ) { | |
| ... | |
| sps_lfnst_enabled_flag | u(1) |
| ... | |
| sps_joint_cbcr_enabled_flag | u(1) |
| if ( (sps_lfnst_enabled_flag ∥ sps_joint_cbcr_enabled_flag) && | |
| sps_explicit_scaling_list_enabled_flag ) | |
| sps_scaling_matrix_for_lfnst_act_disabled_flag | u(1) |
| ... | |

The semantics of this flags are:
sps_scaling_matrix_for_lfnst_act_disabled_flag equal to 1 specifies that scaling matrices are not applied to blocks coded with LFNST or ACT. sps_scaling_matrix_for_lfnst_act_disabled_flag equal to 0 specifies that the scaling matrices may be applied to the blocks coded with LFNST or ACT. When not present, the value of scaling_matrix_for_lfnst_act_disabled_flag is inferred to be equal to 1.
   The decoding process is modified as follows:

```
- The intermediate scaling factor m[ x ][ y ] is derived as follows:
  - If one or more of the following conditions are true, m[ x ][ y ] is set equal to 16:
    - slice_explicit_scaling_list_used_flag is equal to 0.
    - transform_skip_flag[ xTbY ][ yTbY ][ cIdx ] is equal to 1.
    - sps_scaling_matrix_for_lfnst_act_jcbcr_disabled_flag is equal to 1 and ApplyLfnstFlag is equal
      to 1.
    - sps_scaling_matrix_for_lfnst_act_jcbcr_disabled_flag is equal to 1 and
      cu_act_enabled_flag[ xTbY ][ yTbY ] is equal to 1.
```

### Embodiment 3-c: JCBCR Only

If only JCBCR is considered, the following modifications are proposed:

| | Descriptor |
|---|---|
| seq_parameter_set_rbsp( ) { | |
| ... | |
| sps_lfnst_enabled_flag | u(1) |
| ... | |
| sps_joint_cbcr_enabled_flag | u(1) |
| if ( (sps_lfnst_enabled_flag ∥ sps_joint_cbcr_enabled_flag) && | |
| sps_explicit_scaling_list_enabled_flag ) | |
| sps_scaling_matrix_for_lfnst_jcbcr_disabled_flag | u(1) |
| ... | |

The semantics of this flags are:
sps_scaling_matrix_for_lfnst_jcbcr_disabled_flag equal to 1 specifies that scaling matrices are not applied to blocks coded with LFNST or JCBCR. sps_scaling_matrix_for_lfnst_jcbcr_disabled_flag equal to 0 specifies that the scaling matrices may be applied to the blocks coded with LFNST or JCBCR. When not present, the value of scaling_matrix_for_lfnst_jcbcr_disabled_flag is inferred to be equal to 1.
   The decoding process is modified as follows:

```
- The intermediate scaling factor m[ x ][ y ] is derived as follows:
  - If one or more of the following conditions are true, m[ x ][ y ] is set equal to 16:
    - slice_explicit_scaling_list_used_flag is equal to 0.
    - transform_skip_flag[ xTbY ][ yTbY ][ cIdx ] is equal to 1.
    - sps_scaling_matrix_for_lfnst_act_jcbcr_disabled_flag is equal to 1 and ApplyLfnstFlag is equal
      to 1.
    - sps_scaling_matrix_for_lfnst_act_jcbcr_disabled_flag is equal to 1 and
      tu_joint_cbcr_residual_flag[ xTbY ][ yTbY ] is equal to 1
```

Finally, the joint chroma coding, or joint cb-cr (JCBCR), is another coding mode that mixes the chroma component. It transforms the chroma cb-cr to another domain that has less correlation. With the same motivation for ACT, this invention proposes allowing the encoder to disable the scaling matrices for CU's employing JCBCR.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

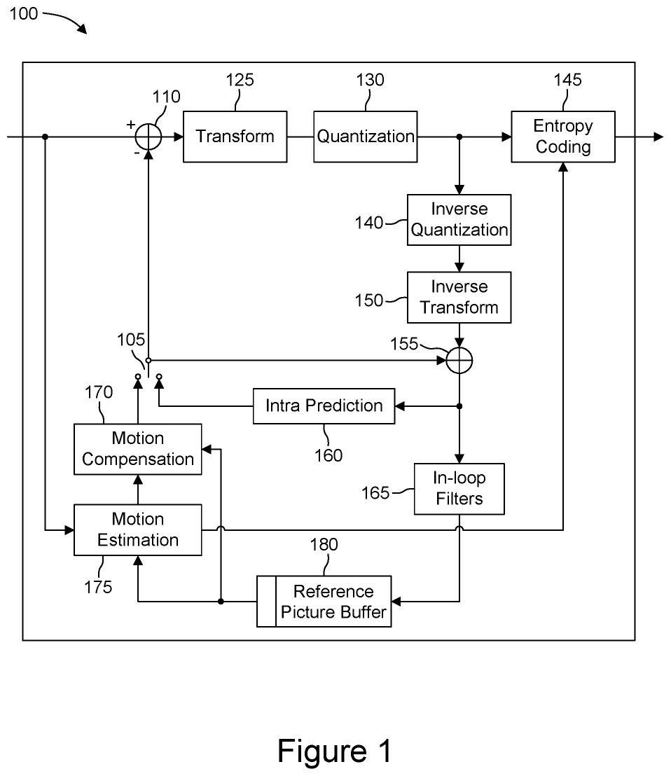

The aspects described and contemplated in this application can be implemented in many different forms. FIGS. 1, 2, and 3 provide some embodiments, but other embodiments are contemplated and the discussion of FIGS. 1, 2, and 3 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. While the terms “encoding” or “encoded” can refer to a signal within or after processing by an encoder, it can also be used to describe a signal in the process of but before fully being decoded. The term “decoded” or “being decoded” may refer to a signal within a decoder, or after processing by a decoder.

Various methods are described herein, and each of the methods comprises one or more steps or actions for achieving the described method. Unless a specific order of steps or actions is required for proper operation of the method, the order and/or use of specific steps and/or actions may be modified or combined.

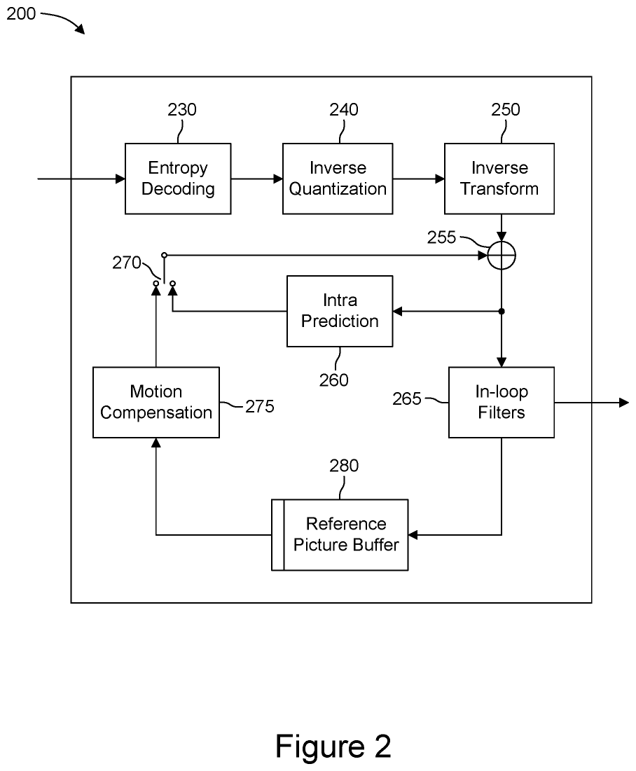

Various methods and other aspects described in this application can be used to modify modules, for example, the intra prediction, entropy coding, and/or decoding modules (160, 360, 145, 330), of a video encoder 100 and decoder 200 as shown in FIG. 1 and FIG. 2. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

FIG. 1 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 2 illustrates a block diagram of a video decoder 200. In the decoder 200, a bitstream is decoded by the decoder elements as described below. Video decoder 200 generally performs a decoding pass reciprocal to the encoding pass as described in FIG. 1. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g. conversion from YCbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

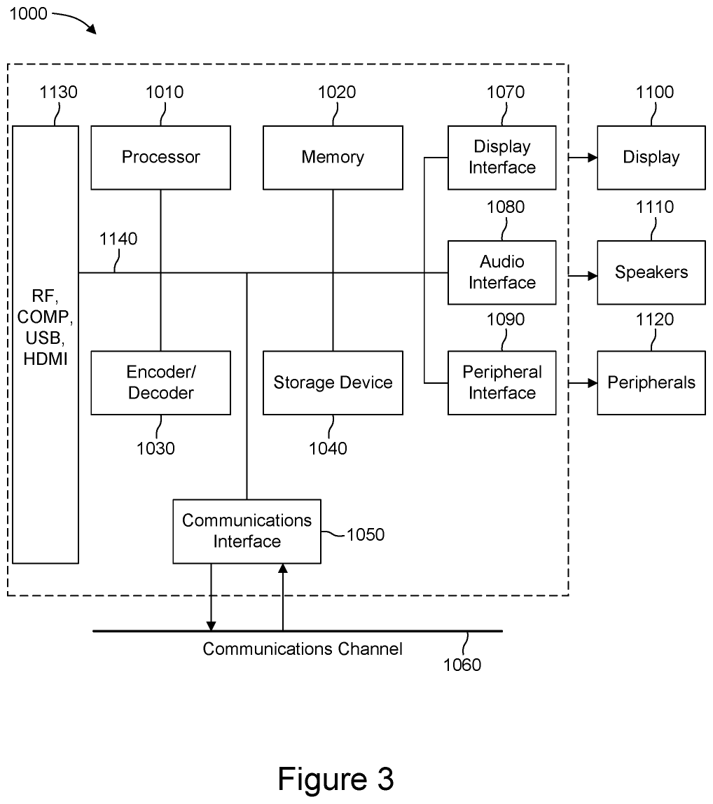

FIG. 3 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 3, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the data stream as necessary for presentation on an output device.

Various elements of system 1000 can be provided within an integrated housing, Within the integrated housing, the various elements can be interconnected and transmit data therebetween using suitable connection arrangement, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other device. The display 1100 can also be integrated with other components (for example, as in a smart phone), or separate (for example, an external monitor fora laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments may refer to parametric models or rate distortion optimization. In particular, during the encoding process, the balance or trade-off between the rate and distortion is usually considered, often given the constraints of computational complexity. It can be measured through a Rate Distortion Optimization (RDO) metric, or through Least Mean Square (LMS), Mean of Absolute Errors (MAE), or other such measurements. Rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of transforms, coding modes or flags. In this way, in an embodiment the same transform, parameter, or mode is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments, across various claim categories and types. Features of these embodiments can be provided alone or in any combination. Further, embodiments can include one or more of the following features, devices, or aspects, alone or in any combination, across various claim categories and types:
A process or device to encode or decode video data using syntax that uses the same flag to control scaling matrices when LFNST is used to control the scaling matrices for ACT and JCBCR.
A process or device to encode or decode video data using syntax that controls the scaling matrices for ACT only.
A process or device to encode or decode video data using syntax that controls the scaling matrices for JCBCR only.
A process or device to encode or decode video data using syntax that controls the scaling matrices at a Sequence Parameter Set level.
A process or device to encode or decode video data using syntax that controls the scaling matrices at a Sequence Parameter Set level when LFNST, ACT, or JCBCR is used.
A process or device to encode or decode video data using syntax that controls the scaling matrices at a Sequence Parameter Set level when LFNST is used.
A process or device to encode or decode video data using syntax that controls the scaling matrices at a Sequence Parameter Set level when ACT is used.
A process or device to encode or decode video data using syntax that controls the scaling matrices at a Sequence Parameter Set level when JCBCR is used.
One of the above processes or devices according to the HEVC or VVC video standard.
A bitstream or signal that includes one or more of the described syntax elements, or variations thereof.
A bitstream or signal that includes syntax conveying information generated according to any of the embodiments described.
Creating and/or transmitting and/or receiving and/or decoding according to any of the embodiments described.
A method, process, apparatus, medium storing instructions, medium storing data, or signal according to any of the embodiments described.
Inserting in the signaling syntax elements that enable the decoder to determine coding mode in a manner corresponding to that used by an encoder.
Creating and/or transmitting and/or receiving and/or decoding a bitstream or signal that includes one or more of the described syntax elements, or variations thereof.
A TV, set-top box, cell phone, tablet, or other electronic device that performs transform method(s) according to any of the embodiments described.
A TV, set-top box, cell phone, tablet, or other electronic device that performs transform method(s) determination according to any of the embodiments described, and that displays (e.g. using a monitor, screen, or other type of display) a resulting image.
A TV, set-top box, cell phone, tablet, or other electronic device that selects, bandlimits, or tunes (e.g. using a tuner) a channel to receive a signal including an encoded image, and performs transform method(s) according to any of the embodiments described.
A TV, set-top box, cell phone, tablet, or other electronic device that receives (e.g. using an antenna) a signal over the air that includes an encoded image, and performs transform method(s).

1. A method, comprising:
generating a sequence parameter set (SPS) flag to control disabling a scaling list for a set of coding blocks, wherein the set of coding blocks were coded with an adaptive color transform (ACT) tool; and
encoding video data including the set of coding blocks based on the SPS flag.

2. An apparatus, comprising:
a processor, configured to:
generate a sequence parameter set (SPS) flag to control disabling a scaling list for a set of coding blocks, wherein the set of coding blocks were coded with an adaptive color transform (ACT) tool; and
encode video data including the set of coding blocks based on the SPS flag.

3. A method, comprising:
receiving a message including information indicating a sequence parameter set (SPS) flag to control disabling a scaling list for a set of coding blocks, wherein the set of coding blocks were coded with an adaptive color transform (ACT) tool; and
decoding video data comprising the set of coding blocks based on the SPS flag.

4. (canceled)

5. The method of claim 1, wherein the SPS flag is indicated in a syntax for controlling scaling matrices, wherein the scaling matrices comprise at least the scaling list.

6. The method of claim 1, further comprising controlling scaling matrices for an adaptive color transform and/or a joint chroma coding.

7. The method of claim 1, wherein the SPS flag indicates that scaling matrices are not applied to the set of coding blocks coded with the ACT tool.

8. The method of claim 1, wherein the SPS flag indicates that scaling matrices are applied to the set of coding blocks coded with the ACT tool.

9. The method of claim 1, wherein the SPS flag is indicated in a syntax for controlling scaling matrices, wherein the syntax comprises multiple flags to control scaling matrices for separate functions.

10. The method of claim 9, wherein the syntax comprises a flag to control scaling matrices for more than one function.

11. The method of 9, wherein the syntax comprises a flag to control scaling matrices for one function comprising either an adaptive color transform or a joint chroma coding.

12. A device comprising:
an apparatus according to claim 1; and
at least one of (i) an antenna configured to receive a signal, the signal including the video block, (ii) a band limiter configured to limit the received signal to a band of frequencies that includes the video block, and (iii) a display configured to display an output representative of a video block.

13. A non-transitory computer readable medium containing data content generated according to the method of claim 1, for playback using a processor.

14-15. (canceled)

16. The apparatus of claim 2, wherein the SPS flag is indicated in a syntax for controlling scaling matrices, wherein the scaling matrices comprise at least the scaling list.

17. The apparatus of claim 2, further comprising controlling scaling matrices for an adaptive color transform and/or a joint chroma coding.

18. The apparatus of claim 2, wherein the SPS flag indicates that scaling matrices are not applied to the set of coding blocks coded with the ACT tool.

19. The apparatus of claim 2, wherein the SPS flag indicates that scaling matrices are applied to the set of coding blocks coded with the ACT tool.

20. The apparatus of claim 2, wherein the SPS flag is indicated in a syntax for controlling scaling matrices, wherein the syntax comprises multiple flags to control scaling matrices for separate functions.

21. The apparatus of claim 20, wherein the syntax comprises a flag to control scaling matrices for more than one function.

22. The apparatus of claim 20, wherein the syntax comprises a flag to control scaling matrices for one function comprising either an adaptive color transform or a joint chroma coding.
